(19) United States
(12) Patent Application Publication
(10) Pub. No.: US 2008/0084951 A1
(43) Pub. Date: Apr. 10, 2008

(54) Systems and methods for receiving multiple input, multiple output signals for test and analysis of multiple-input, multiple-output systems

(76) Inventors: Helen Chen, Santa Rosa, CA (US); Brian J. Avenell, Santa Rosa, CA (US); Gordon R. Strachan, Santa Rosa, CA (US); Michael C. Lawton, Edinburgh (GB)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/544,421

(22) Filed: Oct. 6, 2006

(51) Int. Cl. H04B 7/10

(52) U.S. Cl. 375/347

(57) ABSTRACT

Systems and methods for receiving MIMO signals for testing and analyzing operation of MIMO communications devices. Examples of systems and/or methods for receiving MIMO signals include a measuring receiver with N RF paths consisting of N downconverters. Each downconverter achieves a frequency shift of the input MIMO signal equal to a shifting frequency of a first intermediate frequency (IF) plus a delta determined by the signal bandwidth multiplied by an integer number between 1 and N. The shifted N MIMO signals are combined to generate one combined analog MIMO signal. An analog to digital converter converts the combined analog MIMO signal to a stream of digital samples where the samples may be tested and analyzed with metrics on signals communicated in a MIMO environment. Example systems and method for receiving MIMO signals may also be implemented as a MIMO channel emulator such that samples generated by the ADC may be upconverted to output copies of the original signals to a receiver DUT, for example.

### BACKGROUND OF THE INVENTION

Commercial communication systems are being developed to exploit the use of multiple transmitters and receivers to take advantage of characteristics of the communication medium. A communication medium, such as over-the-air signals from antenna, creates alternative signal propagation paths with different impairment characteristics. In the presence of high impairments in a challenging transmission environment, traditional use of multiple transmitters and receivers reaches a limit in data throughput capacity. MIMO (Multiple Input Multiple Output) communication systems increase data capacity over traditional systems by combining information about the diversity created by impairments in the signal propagation paths with the use of multiple transmitters and receivers. One example of a MIMO system is a mobile telecommunications system where mobile handsets communicate data to other mobile handsets over a MIMO communication interface. An example of such a mobile telecommunications system is the emerging 4G communication systems being developed according to the IEEE 802.16e standard.

MIMO systems recognize that a signal transmitted over the air can transmit multiple propagation paths. A measuring receiver with N multiple input antennae will receive N differently impaired copies of the transmitted signal. The N differently impaired copies allow for a more complete copy to be pieced together than if the receiver only had information from one view from one input antenna. Via digital encoding and modulation techniques M multiple data streams may be transmitted over N transmitted signals, where M can be greater than N. Using the diversity of views of N impaired signals, M data streams may be recovered at a higher capacity than if the impairment diversity information is not used.

The extent of capacity gains of MIMO systems may be determined by the characteristics of the propagation path impairments and the efficacy with which the receiver algorithms exploit these impairments. Therefore, in the design and manufacture of MIMO transmitters, it is desirable to be able to receive and analyze the N transmitted signals to evaluate the signal quality. One solution is a MIMO measurement receiver.

MIMO measurement receivers may provide MIMO system developers with insight into their designs via measurements such as:
RF propagation path metrics such as path phase and amplitude impairments reflected in phase delay, and channel flatness
Modulation quality metrics via parallel digital signal processing for fast demodulation
Transmission origin (direction finding) information
Test of directionality of a transmission via directional receiver sensitivity or “beam steering”

Known multi-channel measurement receivers use one complete signal chain RF path per desired transmitted signal. For handling N transmitted signals, there are N downconversions, N digitizers and N DSP back ends used to resolve M signal data streams. This provides a straightforward approach to acquiring and processing N signals simultaneously to yield very fast processing of multiple channel signal ensembles. These massively parallel architectures are not without disadvantages. Using one complete signal chain per input can be costly to implement. Essentially N complete instruments are needed to handle N signal transmitters to preserve the unique signal characteristics of each input signal.

Another disadvantage is that N complete instruments are difficult to accurately synchronize. They must be closely synchronized in time, phase and frequency alignment since the nature of MIMO demodulation requires that the N views be combined together to use the channel diversity to extract higher capacity in demodulation. Lastly, use of N dedicated DSP processing chains slaved to N ADCs to extract the M data stream signals does not allow for much future flexibility as the emerging MIMO communication systems evolve. What is needed is measuring receivers with the ability to handle MIMO signals without introducing additional impairments from the measuring receiver itself, and without the cost and complexity that plague known solutions.

Similarly, in the design and manufacture of MIMO receivers, the ability to create N transmitted signals with well-controlled known impairments may provide a clear reference point to connect to a device-under-test (“DUT”) MIMO receiver to evaluate the power of the demodulation algorithms. An apparatus that may be used in generating a well-controlled set of impaired signals is called a “channel emulator.” Known channel emulators for MIMO systems suffer from the same deficiencies as known MIMO measurement receivers. That is, known channel emulators compute a complex digital baseband channel for every transmitter-receiver pair. Each baseband channel is then managed in a separate stand-alone piece of hardware. Known channel emulators thus require multiple processing elements to manage each baseband channel. Such solutions are not only expensive, they are further complicated by time, phase and trigger issues raised by the use of separate hardware to manage the channels.

There is a need for channel emulation and measuring receiver solutions for MIMO transmitter and receiver testing that provide high level of signal quality, flexibility, and cost efficiency.

### SUMMARY

In view of the above, examples of systems and methods are provided for receiving multiple-input, multiple output (“MIMO”) signals. Examples of systems and/or methods for receiving MIMO signals include a measuring receiver with N RF paths consisting of N downconverters. Each downconverter achieves a frequency shift of the input MIMO signal equal to a shifting frequency of a first intermediate frequency (IF) plus a delta determined by the signal bandwidth multiplied by an integer number between 1 and N. A signal combiner combines the shifted N MIMO signals to generate one combined analog MIMO signal. An analog to digital converter converts the combined analog MIMO signal to a stream of digital samples where the samples may be tested and analyzed with metrics on signals communicated in a MIMO environment. Example systems and method for receiving MIMO signals may also be implemented as a MIMO channel emulator such that samples generated by the ADC may be upconverted to output copies of the original signals to a receiver DUT, for example.

Various advantages, aspects and novel features of the present invention, as well as details of an illustrated implementation thereof, will be more fully understood from the following description and drawings.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 is a diagram of an example of a system for analyzing a MIMO system using a MIMO measurement receiver.

FIG. 2 is a block diagram of an example system for receiving MIMO signals.

FIG. 3 is a block diagram of an example of a system for receiving MIMO signals using a single-stage downconversion chain for each channel in a MIMO measurement receiver.

FIG. 4 is a block diagram of an example of a system for receiving MIMO signals using a two-stage downconversion chain for each channel in a MIMO signal analyzer system.

FIG. 5A is a block diagram of another example of a system for receiving MIMO signals in a multi-channel measurement receiver.

FIG. 5B is a block diagram of a local oscillator used in the system in FIG. 5A.

FIG. 5C depicts three frequency spectra for signals at various stages of processing in the system of FIG. 5A.

FIG. 6A is a block diagram of a system for analyzing a MIMO system using a MIMO channel emulator.

FIG. 6B is a block diagram of an example of a system for receiving MIMO signals using a single-stage downconversion chain for each channel in a MIMO environment emulator.

FIG. 7 is a flowchart of an example method for receiving MIMO signals.

FIG. 8 is a flowchart of an example method for two-stage downconverting an input MIMO signal.

### DETAILED DESCRIPTION

In the following description of preferred implementations, reference is made to the accompanying drawings that form a part hereof, and which show, by way of illustration, specific implementations in which the invention may be practiced. Other implementations may be utilized and structural changes may be made without departing from the scope of the present invention.

### MIMO Measuring Receiver

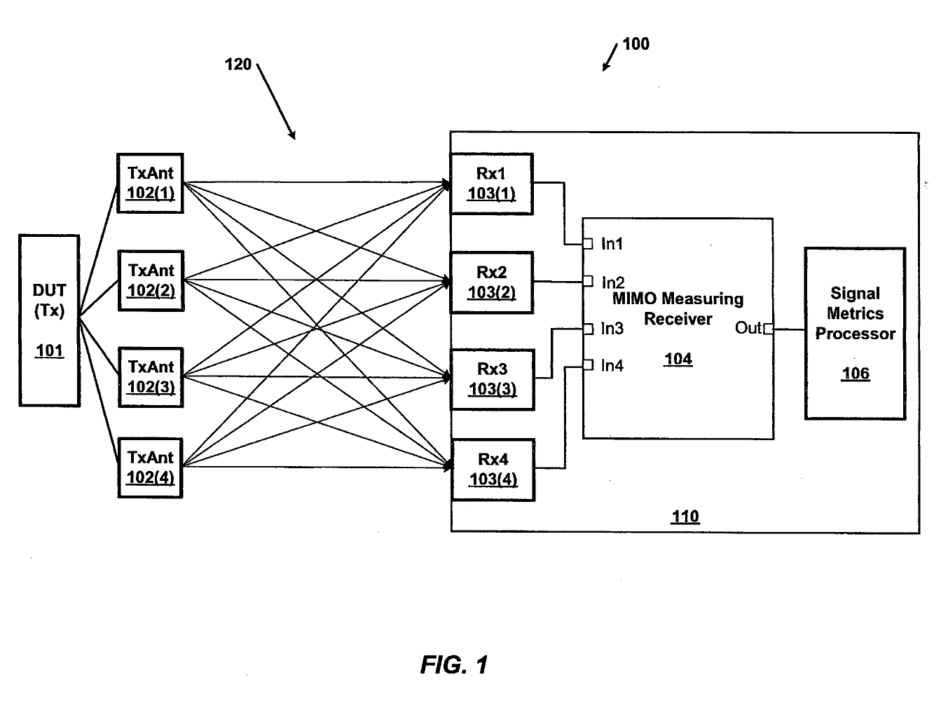

FIG. 1 is a diagram of an example of a system 100 for analyzing a MIMO system using a MIMO measurement receiver 104. The system 100 in FIG. 1 includes a MIMO transmitter 101 connected to four transmitter antennas 102(1)-(4). The MIMO transmitter 101 sends via its antennae 102(1)-(4) multiple transmissions through a propagation medium to a MIMO receiver 110 with the ability to receive multiple input signals simultaneously. For example, FIG. 1 shows the transmitter 101 sending signals via the four transmitting antennae 102(1)-(4) over a set of MIMO channels 120. The channels 120 are received at four receiving antennae 103(1)-(4) of the MIMO receiver 110 with four input paths corresponding to the four receiving antennae 103(1)-(4). The MIMO receiver may include a MIMO measuring receiver 104 containing multiple RF paths.

In FIG. 1, a channel is formed by each signal transmitted from one of the transmitter antennae 102(1)-(4) of the transmitter 101 and its propagation path through the communication medium to one of the receiver antennae 103(1)-(4). Each channel therefore creates a unique image of the transmitted signal at each receiver antennae 103(1)-(4). In the system in FIG. 1, the signal transmitted from the transmitter 101 at the transmitter antenna 102(1) appears differently at the four receiver antennae 103(1)-(4). The receiver 110 receives four different versions of the transmitted signal:
1. A first version from transmission antenna 102(1) to receiver antenna 103(1),
2. A second version from transmission antenna 102(1) to receiver antenna 103(2),
3. A third version from transmission antenna 102(1) to receiver antenna 103(3), and
4. A fourth version from transmission antenna 102(1) to receiver antenna 103(4).
   As shown in FIG. 1, the signals from each receiver antennae 103(1)-(4) are coupled to an input of a MIMO measuring receiver 104. At the input of the MIMO measuring receiver 104, the signals are routed to a RF path within the MIMO measuring receiver 104. As described below with reference to the drawings, the received signals are frequency shifted and then combined into a single RF signal, creating a frequency multiplexed version combining the signals received at each receiver input. Thus, the MIMO spatial diversity is converted into a frequency multiplexed ensemble signal that preserves the spatial diversity in such a way as to preserve the information as still separable. This RF frequency multiplexed signal is then sampled using an analog-to-digital converter (“ADC”). The digital samples may then be operated upon via DSP algorithms to separate the information from each channel, and extract M demodulated data streams, where M is may be greater than N. As shown in the example in FIG. 1, the digital samples may be processed by a signal metrics processor 106.

In examples of systems and methods for receiving MIMO signals, the use of frequency multiplexing, combining, and using a single ADC to sample the frequency multiplexed signal provides instantaneously near perfect synchronous capture of all MIMO spatial streams. The example shown in FIG. 1 may be advantageously used to test a device that transmits using MIMO technology. For example, the transmitter 101 may be a 4G mobile telephone, and the 4G mobile phone may be a device under test (“DUT”). By using the MIMO receiver 110 in a test system, the signals transmitted by the mobile phone 101 may be analyzed as perfectly captured MIMO spatial streams.

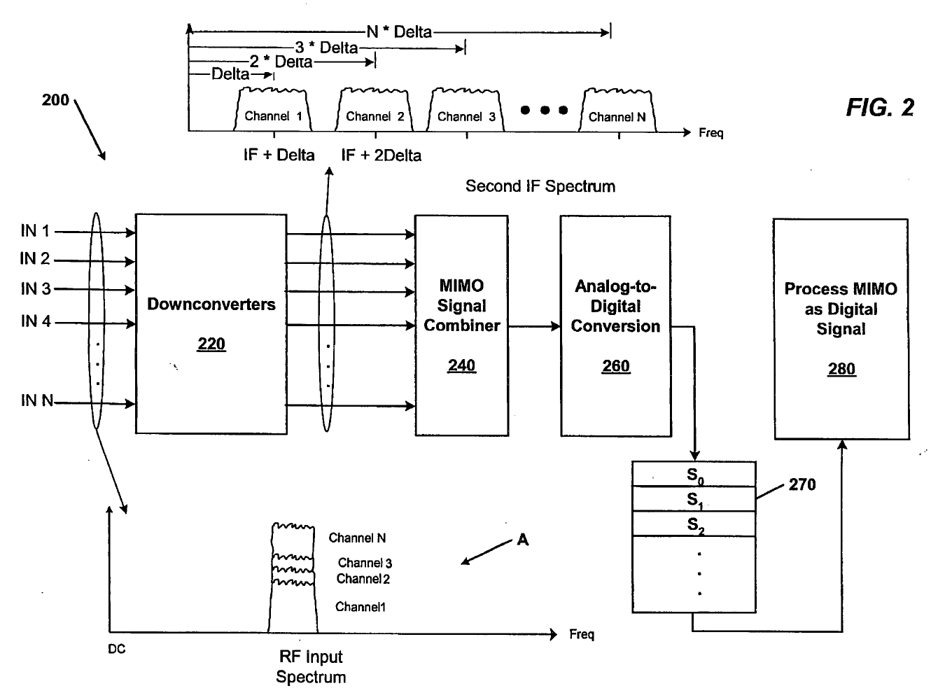

FIG. 2 is a block diagram of an example measuring receiver system for MIMO signals. The MIMO signals are received by a receiver 200 containing N RF bands with N inputs (labeled as “IN 1,” “IN 2,” “IN 3,” . . . “IN N” in FIG. 2). The receiver RF path includes a downconverter 220 for each input channel signal. Except where explicitly noted otherwise, the term “channels” shall be used to refer to the communication path formed by a specific transmitted signal and receiver input combination. Therefore, for a transmitter sending two signals to a receiver with two RF input paths, there are four channels. For a transmitter sending four signals to a receiver with four RF input paths, there are sixteen channels.

The signals output from the downconverters 220 may be output to a signal combiner 240. The MIMO signals are overlapping in that they are being communicated over the same frequency band. FIG. 2 shows a frequency spectrum at A that illustrates the MIMO signals communicated in an overlapping frequency band on the multiple channels in the example MIMO system shown in FIG. 2.

The downconverters 220 receive MIMO signals from corresponding channels and downconvert each signal to a common intermediate frequency (“IF”) plus a predetermined narrow band shifted by an increment, Δ. The Δ shift may be designed to be any suitable incremental frequency value. Similarly, the predetermined narrow band may also be designed to be any suitable frequency bandwidth. In examples described, the predetermined narrow band may be the bandwidth of the channels plus an amount sufficient to attenuate distortion and image products. The Δ shift may be the narrow band multiplied by an integer number between 1 and N to distribute the MIMO signals across non-overlapping bands in the frequency spectrum. The frequency spectrum at B in FIG. 2 shows the downconverted MIMO signals distributed on a wide frequency band. The downconverted MIMO signals are combined into one wideband signal at the signal combiner 240 to output a combined MIMO signal. The combined MIMO signal is an analog signal that combines signals from any number of the MIMO channels separated by frequency multiplexing into their own frequency bands.

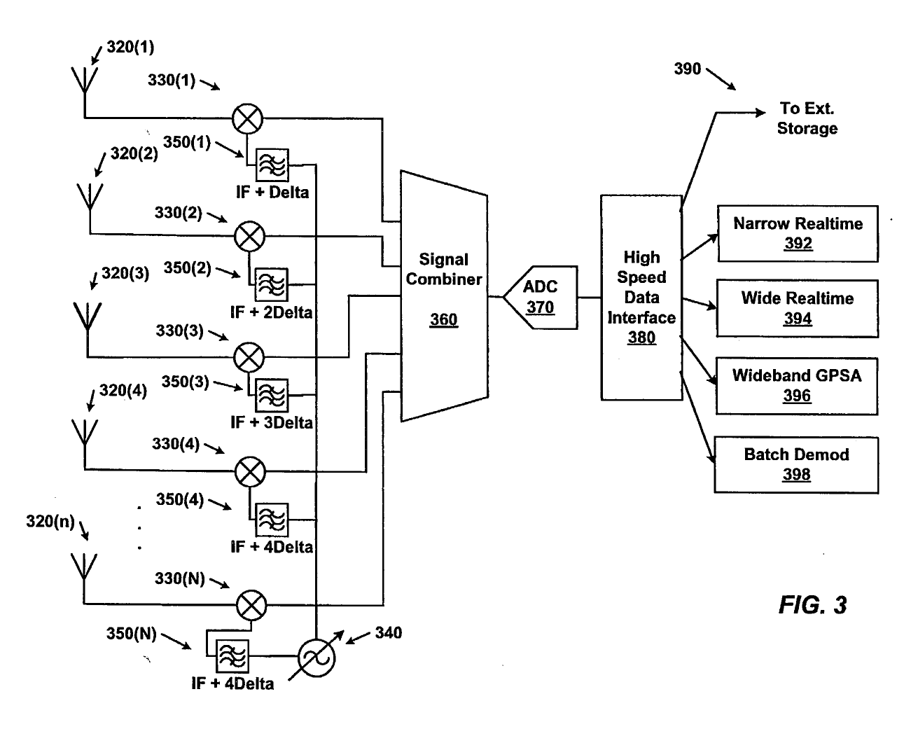

The combined MIMO signal output from the signal combiner 240 in FIG. 2 is coupled to an analog-to-digital converter 260 to permit processing of the combined MIMO signal as a collection of digital samples, shown in FIG. 2 as a buffer 270 containing samples S₀, S₁, S₂, . . . . The combined MIMO signal may be centered at a high frequency and may carry signals from many channels. Thus, the analog-to-digital converter 260 in FIG. 2 processes the combined MIMO signal using a high sampling rate and a sample word size that is sufficient to capture all of relevant information being carried by each MIMO signal received. The samples in the sample buffer 270 may then be processed as digital signals at 280 in accordance with the application selected for the example multiple channel receiver 200 in FIG. 2. Examples of applications that may implement the receiver 200 in FIG. 2 include a MIMO signal analyzer such that the samples would be processed as digital signals at 280 according to functions of a MIMO signal analyzer (examples of which are described below with reference to FIGS. 3-5).

Combining the MIMO signals advantageously preserves the unique characteristics of each received input signal by translating physical/space diversity (i.e. inputs from separate antennae) into a frequency multiplexed signal. This multiple channel measurement receiver allows multiple input signals at the same carrier frequency to the downconverted into a common shared sampling/acquisition system (if bandwidth wide enough to handle the frequency multiplexed signal).

FIG. 3 is a block diagram of an example of a system for receiving MIMO signals using a two-stage downconversion chain for each channel. The multiple inputs in FIG. 3 are shown as antennas 320(1)-320(N) coupled to a corresponding mixer 330(1)-330(N). Each MIMO signal received by the antennas 320(1)-320(N) is mixed at the corresponding mixers 330(1)-330(N) with a corresponding IF signal. The corresponding IF signal is generated in the system of FIG. 3 by a a common local oscillator (“LO”) 340 that may be tunable to allow for selection of an optimal IF frequency. At each mixer 330(1)-330(N), a multiplexing IF signal is generated by filtering the IF signal at a corresponding delta bandpass filter 350(1)-350(N). The delta bandpass filters 350(1)-350(N) are centered at shifting frequencies that are determined, for each filter 350(1)-350(N), using F_{shift}=IF+Δ*channel number in a manner similar to that described above with reference to FIG. 2.

The output of each delta bandpass filter 350(1)-350(N) is the corresponding IF signal that corresponds with each MIMO input. The input signal is mixed with each corresponding IF signal to generate a shifted frequency signal. The shifted frequency signals, which are non-overlapping on the frequency spectrum, are input to a signal combiner 360 to generate a combined analog frequency multiplexed MIMO signal.

The combined analog frequency multiplexed signal is coupled to a high-bandwidth analog-to-digital converter 370 for conversion to digital data. As described above with reference to FIG. 2, the sampling rate and data word width of the high-bandwidth ADC 370 in FIG. 3 depend on the characteristics of the MIMO signals being measured, and on the number of inputs from which measurements are being taken.

The digital data that represents the combined MIMO analog signal may then be processed by a MIMO signal analysis system. The digital samples of the combined MIMO signals are input to a high-speed data interface 380, which may be controlled to direct the data to a functionally appropriate measurement sub-system. The high-speed data interface 380 receives the digital data and may employ a high speed data fabric to communicate the samples to an appropriate function. The high-speed data interface 380 may decode the digital data samples to identify the channels in the combined signal. The digital data from the individual channels may also be stored in high-speed memory of any type (i.e. disk, RAM, etc.). A shown in FIG. 3, the data may be communicated to external storage 390 or to functions for analyzing the signals.

With respect to the high-speed data interface 380, the ADC generates a digital sampled version of the signal which may then be processed with DSP algorithms. The processing demand of handling N x N signal channels in a MIMO system may be very large, which may require the use of very high speed and parallel processing of the output ADC data stream. In examples of the system in FIG. 3, the use of industry standard data switching fabrics in the high-speed data interface 380 allow the receiver to dynamically allocate DSP resources to the measurement task of the moment. The data fabric within the measuring receiver allows the same ADC data stream to be transmitted to multiple DSP engines simultaneously for distributed DSP algorithms to run on the same data.

FIG. 3 shows several categories of analysis that may be performed on the digital form of the MIMO signals. Categories of signal analysis may include, without limitation, narrow real-time analysis 392, wide real-time analysis 394, wideband general purpose spectrum analysis (“GPSA”), and batch demodulation 398. Wideband and narrow-band real-time analysis 392, 394 may include real-time demodulation of the data stream and extraction of knowledge from the data stream. This may include metrics such as BER or channel occupation statistics. GPSA may include determining whether a transmitter complies with the expected frequency emissions mask defined by a standard (i.e. to prevent interference between users); or simple signal characteristics such as signal power, bandwidth, etc. Batch demodulation or batch metrics may include EVM where signal quality metrics are calculated on snapshots of the symbol stream but not necessarily in real-time.

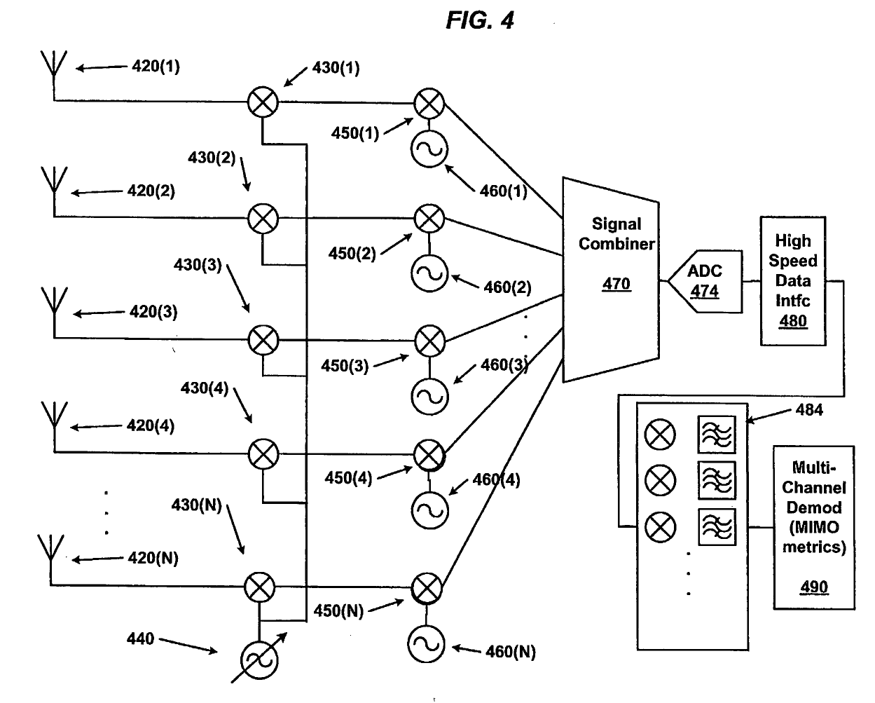

FIG. 4 is a block diagram of an example of a system for receiving MIMO signals using a two-stage downconversion chain for each channel. The multiple inputs in FIG. 4 are shown as antennas 420(1)-420(N) coupled to a corresponding stage 1 mixer 430(1)-430(N). Each MIMO signal received by the antennas 420(1)-420(N) is mixed at the corresponding mixers 430(1)-430(N) with a first IF signal at a first IF frequency generated by a common local oscillator (“LO”) 440. The common LO 440 may be tunable to allow for selection of an optimal IF frequency. The stage 1 mixers 430(1)-430(N) output a first mixed MIMO signal to a corresponding stage 2 mixer 450(1)-450(N). The first mixed MIMO signals are mixed at corresponding stage 2 mixers 450(1)-450(N) with a second IF signal. The second IF signals are generated by corresponding unique local oscillators 460(1)-460(N). Each of the second IF signals has a second IF frequency that is used in frequency multiplexing the received MIMO input signals. The stage 2 mixers 450(1)-450(N) shift each MIMO input signal from the first IF frequency along a frequency spectrum. The stage 2 mixers 450(1)-450(N) output corresponding second mixed MIMO signals. Each second mixed MIMO signal is input to a signal combiner 470.

The signal combiner 470 in FIG. 4 outputs an analog frequency multiplexed combined MIMO signal to an analog to digital converter 474 in a manner similar to that described above with reference to FIGS. 2 and 3. The ADC 474 outputs digital samples to a high-speed data interface 480 in a manner similar to that described above with reference to FIG. 3. The high-speed data interface 480 may separate the signal into its component MIMO signals and convert the digital samples back to its original analog baseband signal using a multi-channel demodulator 484. Each signal may then be input to a MIMO metrics system 490, which may measure desired signal characteristics of the individual MIMO signals.

The MIMO metrics system 490 may include any suitable metrics, which would depend on the specific signal characteristics being measured, the specific environment the signals are to be operating in, etc. For example, a MIMO signal analysis system may be used to measure signals generated by devices designed to operate under the IEEE 802.11n specification, which is intended to enhance wideband data transmission in mobile consumer applications. The standard specifies 20 and 40 MHz bandwidth signals using MIMO spatial diversity to expand capacity. Many types of metrics may used to measure 802.11n signals. Some specific metrics that may be used include:
1. Beam forming demodulation: Allows for the display of a spectrogram of the channel response of the multiple spatially diverse channels after demodulation. In addition, the degree of coherence between channels measures the effectiveness and accuracy of the beam form. This metric drives time coherency requirements (<3 ns) that may advantageously be met by examples of systems for receiving MIMO signals such as those described with reference to, at least, FIGS. 2-5C.
2. Channel-to-channel time and phase delay: By solving the channel model matrix (as part of demodulation of the MIMO channels), the characteristics of the channel may be further measured. Metrics such as channel-to-channel time and phase delay may require time synchronous capture, which is advantageously provided by examples of systems such as those described with reference to, at least, FIGS. 2-5C.
3. Channel response metrics: Channel frequency response would also be a beneficial metric, which may depend on the quality of the metrics receiver for an accurate picture of channel and transmitter impairments. High speed channel matrix solving is enabled by the data fabric and multiple DSP capability of our architecture.
4. Modulation quality: EVM (Error vector magnitude) of all demodulated spatial streams. Compare the EVM of the multiple space diverse channels. Again DSP speed for demod is enabled by our architecture.

Other types of metrics may be implemented in a MIMO metrics system 490.

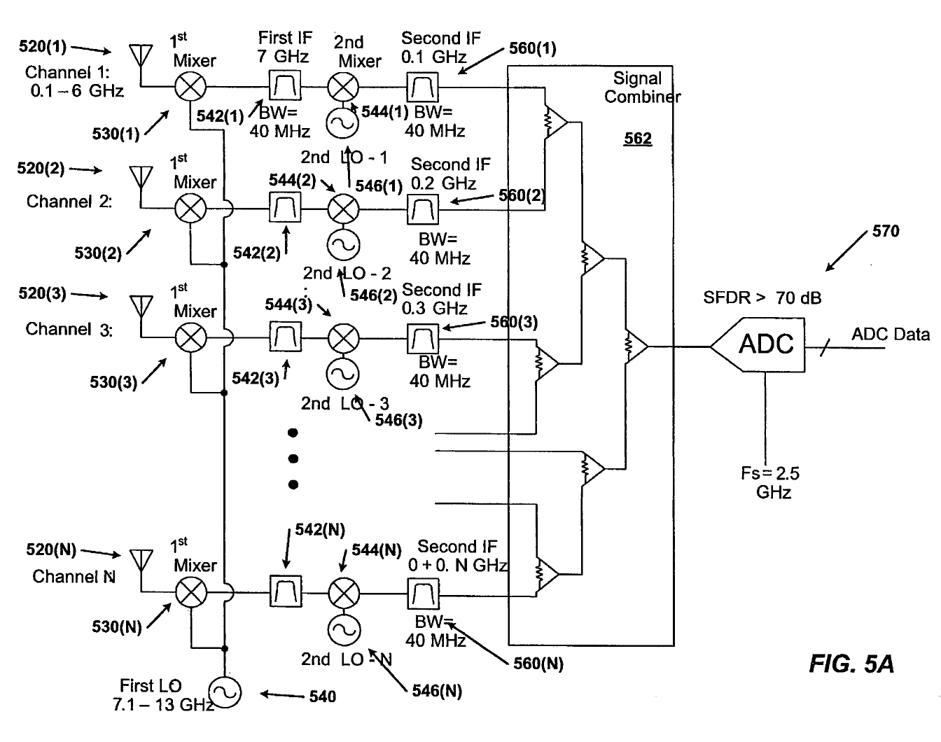

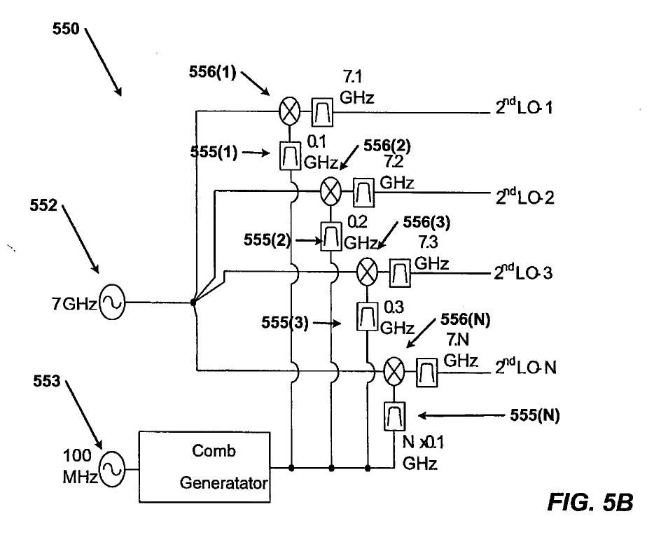

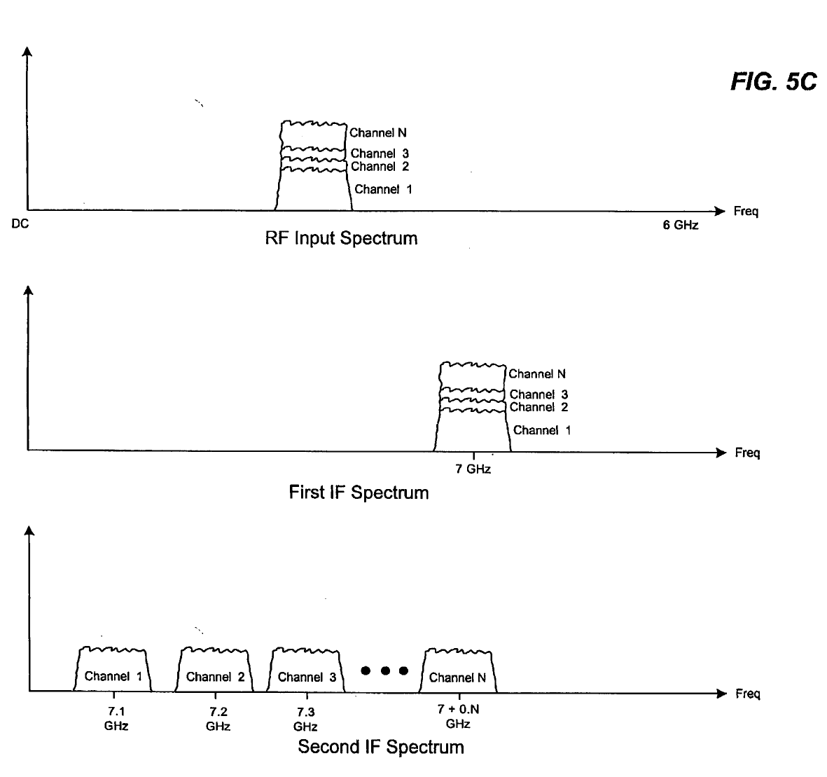

FIG. 5A is an RF Block diagram showing a N-Channel receiver 500 that may be used as a receiver in MIMO applications. FIG. 5B is a schematic diagram of a second IF local oscillator used in the receiver in FIG. 5A. FIG. 5C shows the frequency spectrums of an RF input signal spectrum 590, a first IF signal spectrum 592and a second IF signal spectrum 594.

The MIMO signals are input at channels 1-N at antennas 520(1)-520(N) as shown in FIG. 5A. The MIMO signals are depicted in FIG. 5C at the RF input spectrum 550 as spread spectrum signals occupying 40 MHz bandwidth with all signals centered at the same frequency somewhere between 100 MHz and 6 GHz. The MIMO signals are input to a first mixer 530(1)-530(N) where the MIMO signals are mixed with an IF signal generated by a first LO 540. The first LO 540 is shared between all channels with a frequency range such that the signals at each channel are upconverted to a 7 GHz first IF signal. The first IF signal spectrum 592 for each channel (shown in FIG. 5C) shows all of the channels shifted to have a center frequency of 7 GHz.

The first IF signal may be input to a bandpass filter 542(1)-(N) at each channel to limit the bandwidth of the signal to the original MIMO signal bandwidth. The bandpass filters 542(1)-(N) have a center frequency of 7 GHz and a bandwidth of about 40 MHz. The first IF signal is then input to a second mixer 544(1)-544(N), where it is mixed with a second IF shifting signal generated by a second LO 546(1)-(N).

The second LO 546(1)-546(N) for each channel generates a fixed frequency, which, for each channel, would be a 2nd LO frequency offset by 100 MHz from one another. FIG. 5C shows an example of a local oscillator 550 that may be used to generate the signal generated by the second LO 546(1)-546(N). Synthesis of the second IF signal is starts with a 7 GHz fixed oscillator 552. A second oscillator 553 generates a 100 MHz signal, which is input to a comb generator 554, which produces an output rich in harmonics of the 100 MHz input signal. N bandpass filters 555(1)-555(N) output the desired comb output signal starting with 100 MHz at bandpass filter 555(1) and ending with N*100 MHz (N is the number of channels in the system) at bandpass filter 555(N). Each filtered comb signal is mixed with the 7 GHz signal at second IF signal mixers 556(1)-556(N) to produce signal outputs of 7.1 GHz, 7.2 GHz, . . . 7+(N*0.1) GHz, which are output as the second LO frequency signals. The second LO frequency signals downconvert the first IF signal down to a final IF signal, which is filtered by final IF bandpass filters 560(1)-560(N) as shown in FIG. 5A. In each channel the final IF frequency is offset by 100 MHz from one another as shown in the second IF spectrum 594 in FIG. 5C. All final IF frequencies are then power combined into a single output at a signal combiner 562. This output is then fed into a high speed, high dynamic range ADC 570 as described above. The ADC 570 shown in FIG. 5A has a sampling rate of 2.5 GHz. Those of ordinary skill in the art will appreciate that a suitable sampling rate may depend on a wide variety of factors such as the number of channels being processed, the frequency values selected for the first and second IF frequencies, the bandwidth of the MIMO signals, and other factors.

### MIMO Channel Emulator

In examples of systems and methods for receiving MIMO signals, a MIMO environment emulator may be used in testing devices under development for use in a MIMO environment. For example, a MIMO device may be attached to one or more of the multiple outputs of a MIMO environment emulator to test its performance in an emulated MIMO environment. Test signals may be injected into the MIMO emulator at antennas, or other forms of input, at the multiple inputs. The MIMO emulator advantageously preserves the signal characteristics as a MIMO environment as the signals are communicated to the device(s) under test.

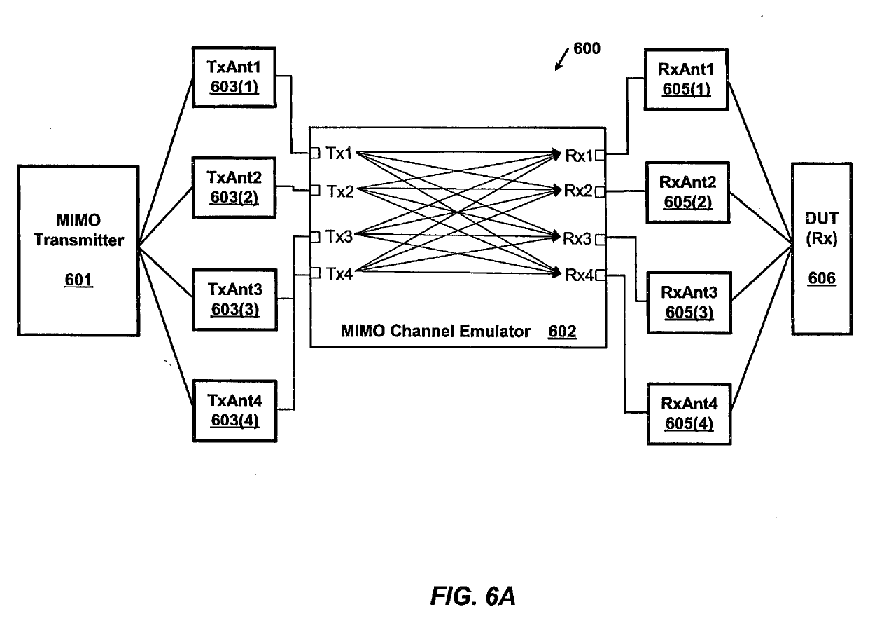

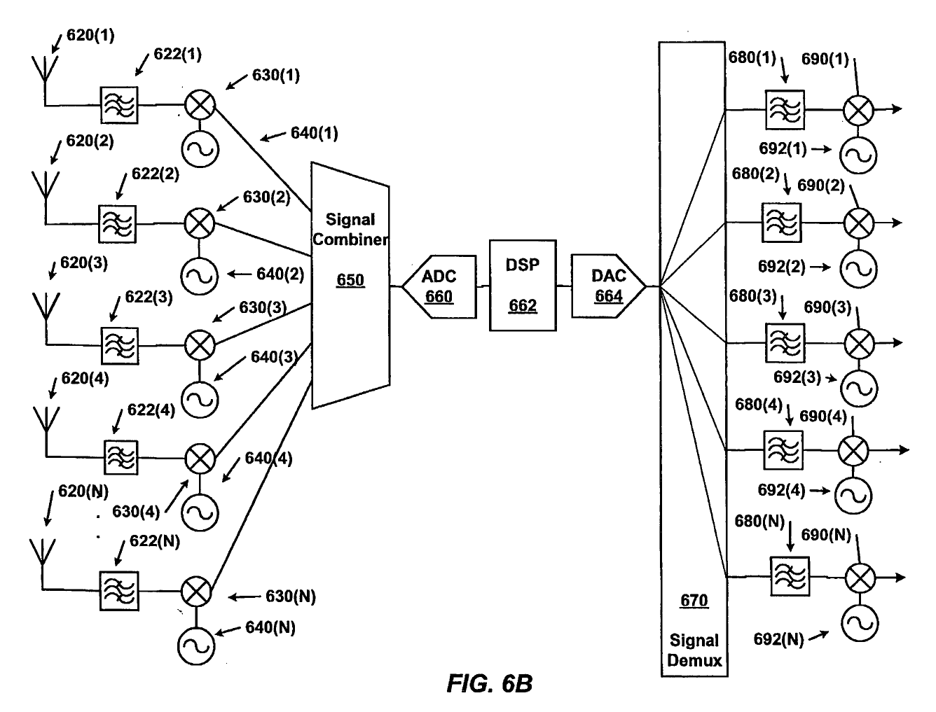

FIG. 6B is a block diagram of an example of a system for receiving MIMO signals using a single-stage downconversion chain for each input in a MIMO environment emulator. The system in FIG. 6B includes antennas 620(1)-620(N) similar to the transmitter antennae 603(1)-(4) shown in FIG. 6A. The antennae 620(1)-(N) are coupled to corresponding input bandpass filters 622(1)-622(N) tuned to filter out signals not in the MIMO signal baseband bandwidth. The example system shown in FIG. 6B operates as a MIMO environment emulator to advantageously provide designers with a way of testing devices intended for a specific MIMO environment. For example, the specific MIMO environment may be a 4G standard environment and the system in FIG. 6B may be used to test devices designed to operate according to 4G standards. The MIMO channel emulator in FIG. 6B may be advantageously used to test functions for receiving MIMO signals in a 4G handset.

Referring to FIG. 6B, the filtered MIMO signal is mixed at a corresponding mixer 630(1)-630(N) with a shifting frequency signal generated by a corresponding shifting local oscillator (“LO”) 640(1)-640(N). The shifting frequency signal has a frequency that shifts each MIMO input signal to a signal having a center frequency at an intermediate frequency (“IF”) plus a shift equal to Δ multiplied by an integer corresponding to a channel number that is unique to each of the MIMO signal inputs.

In one example of a system for receiving MIMO signals, the shifting local oscillators 640(1)-640(N) may generate a signal with a shifting frequency of F_{shift}, where F_{shift}=IF+Δ*channel number. Thus, for the first shifting local oscillator 640(1), F_{shift}=IF+1*Δ; or the second shifting local oscillator 640(2), F_{shift}=IF+2*Δ. For the third local oscillator 640(3), F_{shift}=IF+3*Δ. The remaining shifting local oscillators 640(4)-240(N) generate signals having shifting frequencies for the N channels according to the above definition of F_{shift}. The shifting frequency of the signal generated by the Nth shifting local oscillator is F_{shift}=IF+N*Δ.

The shifting local oscillators 640(1)-640(N) are mixed with the bandpass filtered MIMO input signals at mixers 630(1)-630(N) to output the MIMO signal shifted to its shifted frequency along the frequency spectrum. The shifted MIMO signals are then combined at a signal combiner 650 to produce a combined analog MIMO signal that may have a spectrum similar to the frequency spectrum B in FIG. 2. The combined analog MIMO signal is coupled to an ADC 660, which samples the signal and converts it to a sequence of digital samples. The combined analog MIMO signal may be a high bandwidth signal as it may include signals received from many channels and spread out over the frequency spectrum around a rather high frequency IF. Accordingly, the ADC 660 in FIG. 6B has a suitably high sampling rate to ensure that the conversion captures all of the characteristics of the original signal. In one example having four inputs, four outputs, and MIMO signals with bandwidths of about 40 Mhz, a suitable sampling rate for the ADC 660 may be 200-240 MHz. The ADC 660 in FIG. 6B also generates samples with a suitably wide data width.

The digital samples generated by the ADC 660 are then processed by a DSP block 662. The DSP block 662 may perform any appropriate digital signal processing function. The example system for receiving MIMO input signals in FIG. 6B is used to emulate a MIMO environment to enable testing of devices that are used in a MIMO system. The DSP block 662 in FIG. 6B may include functions that manage channels to direct signals to an upconversion stage for reconstruction of each channel. As noted above, the MIMO channel emulator 602 in FIG. 6A may be advantageously used to test receiver functions in MIMO devices. A function in the DSP block 662 may be included to impair the signal in well-controlled and deterministic ways. A perfect signal may be combined with controlled multipath or group delay to create a test signal to see if a DUT MIMO receiver can perform receiving such a signal.

The DSP block 662 outputs the digital stream of samples to a digital to analog converter (“DAC”) 664, which converts the digital representation of the MIMO combined analog signal back to its analog form. The converted MIMO combined analog signal is de-multiplexed by a signal de-multiplexer 670 using information obtained by the DSP block 662 to direct each MIMO input signal to its intended destination output. The signal de-multiplexer 670 outputs each MIMO analog signal to an output demodulating chain. Each demodulating chain includes a bandpass filter 680(1)-680(N), a demodulating mixer 690(1)-690(N) and a demodulating local oscillator 692(1)-692(N). The demodulating chain converts the MIMO signal received from the signal de-multiplexer 670 back to baseband MIMO signal input. The bandpass filters 680(1)-(N) have a center frequency that is the same as that of the MIMO input signals.

The MIMO signals received from the signal de-multiplexer 670 is mixed with a de-modulating signal output by the demodulating local oscillators 692(1)-692(N). The output of the mixers 690(1)-690(N) represents the baseband signal for each MIMO input signal. The system of FIG. 6B advantageously emulates the MIMO environment so that the signal at the outputs includes all of the characteristics of the MIMO input signals received at antennas 620(1)-620(N). The system of FIG. 6B thus advantageously provides designers of devices that operate in a MIMO environment with a system for emulating the MIMO environment in which their devices may be tested.

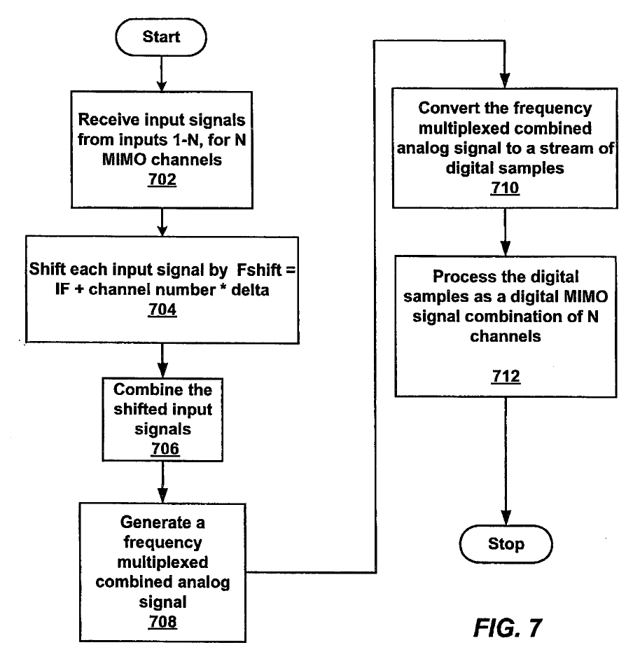

FIG. 7 is a flowchart of an example method for receiving MIMO signals. The method begins at step 702 with the reception of MIMO input signals at one or more of N MIMO channels. At step 704, each MIMO input signal is frequency multiplexed by combining the input signal with a signal having a shifting frequency, F_{shift}=IF+channel number*Δ. At step 706, the shifted signals from each channel are combined and at step 708, one frequency multiplexed combined analog MIMO signal is generated. The frequency multiplexed analog signal is converted to digital samples at step 710. At step 712, the digital samples are processed by an appropriate MIMO signal processing system. As described above, the digital samples may be processed as a MIMO environment emulator, so that channels would be defined and the MIMO input signals are communicated to the appropriate outputs. The digital samples may also be analyzed to extract desired information about signal characteristics of the MIMO input signals.

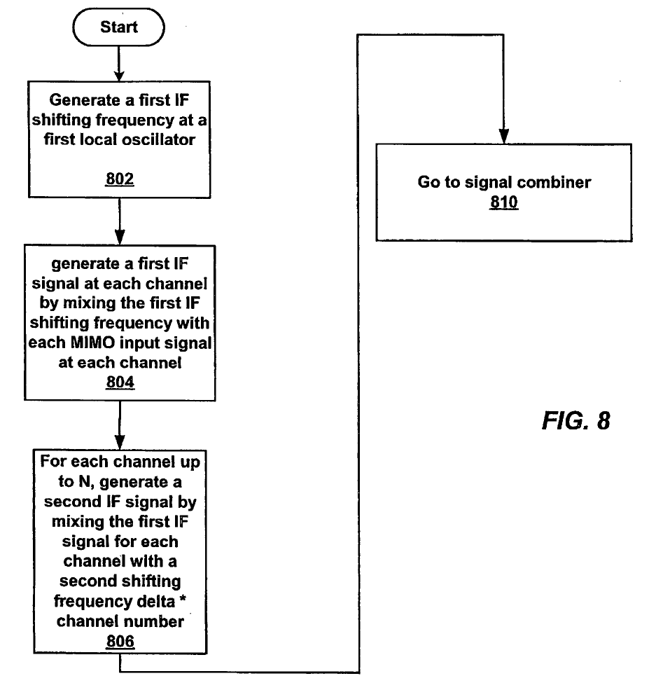

FIG. 8 is a flowchart of an example of a method for performing step 704 in FIG. 7, which is frequency multiplexing the input signal. The method in FIG. 8 is a two-stage downcoversion method. Those of ordinary skill in the art will appreciate that a single-stage conversion may be used as well.

In FIG. 8, at step 802, a first shifting frequency is generated at a first local oscillator. A first IF signal is generated at each channel by mixing the first IF shifting frequency with each MIMO input signal at each channel at step 804. In step 804, each MIMO input signal is mixed with the same IF frequency so that all of the MIMO input signals are shifted up to the IF frequency. In step 806, for each channel up to channel N, a second IF signal is generated by mixing the first IF signal for each channel with a second shifting frequency=Δ*channel number. The signals from each channel are then combined at step 810.

Examples of systems and methods for receiving MIMO signals in a test/analysis environment, such as examples of the MIMO measuring receiver and the channel emulator described above, advantageously convert the physical diversity from multiple inputs to a frequency diversity to obtain a perfectly time synchronous capture of the signal of interest. These test instruments may then use a data fabric to handle the possibly high-volume data stream to multiple kinds of backend processing, one of which might be demodulation-adding deliberate impairments-and then demodulation and upconversion to send out a signal (e.g. channel emulator function).

Examples of systems and methods for receiving MIMO signals described above implement downconversion techniques and Those of ordinary skill in the art will appreciate that other methods of frequency multiplexing the input MIMO signals and combining the MIMO signals for processing as one single analog signal may also be used without departing from the scope of the invention.

The foregoing description of implementations has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

What is claimed:

1. A system for receiving multiple-input, multiple output (“MIMO”) signals comprising:
N inputs defining N MIMO channels for receiving MIMO signals;
N downconverters to shift each MIMO signal to a shifting frequency of a first intermediate frequency plus a delta multiplied by an integer number between 1 and N;
a signal combiner to combine the shifted MIMO channel input signals to generate one combined analog MIMO signal; and
an analog to digital converter to convert the one combined analog MIMO signal to a stream of digital samples for processing as signals communicated in a MIMO environment.

2. The system of claim 1 where the N channel downconverters further comprise:
a single mixing stage for combining each MIMO input signal with a shifting frequency signal generated by a local oscillator at each channel.

3. The system of claim 1 where the N channel downcoverters further comprise:
a first mixing stage for combining each MIMO input signal with a common first IF shifting frequency signal to generate a first IF signal at each channel; and
a second mixing stage for combining each first IF signal at each channel with a second IF signal where each second IF signal frequency is Δ*the channel number, to generate a second IF signal at each channel.

4. The system of claim 1 further comprising:
a digital signal processing block to receive the digital samples and to determine an output for the channel;
a digital to analog converter and demodulation processor for converting the digital samples back to analog form and demodulating the analog form to generate a baseband version of each MIMO channel; and
an upconverter to generate a copy of the original channel at the output for the channel.

5. The system of claim 1 where the N channel downconverters further comprise:
a single mixing stage for combining each MIMO input signal with a shifting frequency signal generated by a local oscillator at each channel.

6. The system of claim 1 where the N channel downcoverters further comprise:
a first mixing stage for combining each MIMO input signal with a common first IF shifting frequency signal to generate a first IF signal at each channel; and
a second mixing stage for combining each first IF signal at each channel with a second IF signal where each second IF signal frequency is a value, Δ*the channel number, to generate a second IF signal at each channel.

7. A system for testing receiver functions in a first MIMO communications device comprising:
a second device to transmit MIMO signals via a plurality of transmitter antennas; and
the system of claim 4 connected to the first MIMO communications device to receive the copy of the original channel at the first MIMO communications device.

8. The system of claim 1 further comprising:
a MIMO signal measurement system to analyze the MIMO signal using selected metrics.

9. The system of claim 8 where the N channel downconverters further comprise:
a single mixing stage for combining each MIMO input signal with a shifting frequency signal generated by a local oscillator at each channel.

10. The system of claim 8 where the N channel downcoverters further comprise:
a first mixing stage for combining each MIMO input signal with a common first IF shifting frequency signal to generate a first IF signal at each channel; and
a second mixing stage for combining each first IF signal at each channel with a second IF signal where each second IF signal frequency is a value, Δ*the channel number, to generate a second IF signal at each channel.

11. The system of claim 8 further comprising:
a high-speed data interface to a signal metrics processor, the high-speed data interface including a data fabric.

12. A system for testing receiver functions of a MIMO communications device comprising the system of claim 8 to receive MIMO signals from the MIMO communications device for analysis.

13. A method for receiving MIMO signals comprising:
receiving input signals from 1 to N MIMO channels;
shifting each input signal by a shifting frequency so that each MIMO input signal occupies a non-overlapping region of a MIMO bandwidth;
combining one or more of the shifted MIMO input signals to generate a combined, frequency multiplexed MIMO analog signal; and
converting the combined frequency multiplexed analog signal to digital samples for processing.

14. The method of claim 13 where the step of shifting each input signal comprises:
generating a first intermediate frequency signal;
generating the shifting frequency for each channel 1 to N by bandpass filtering the first intermediate frequency signal at a bandwidth delta multiplied by a corresponding integer channel number between 1 and N; and
mixing the shifting frequency with each input signal from the corresponding channel 1 to N.

15. The method of claim 13 where the step of shifting each input signal comprises:
generating the shifting frequency, F_{shift} for each channel 1 to N according to F_{shift}=Fᵢₙₜ+delta*n, where n=a corresponding integer channel number between 1 and N;
mixing the shifting frequency for each channel with the input signal at the corresponding channel.

16. The method of claim 13 where the step of shifting each input signal comprises:
generating a first intermediate frequency signal;
mixing the first intermediate frequency signal with each input signal at each channel a mixed input frequency signal;
generating a second intermediate frequency corresponding to each channel 1 to N where each second IF frequency is Δ multiplied by the channel number; and
mixing each second intermediate frequency at each channel number with each corresponding mixed input frequency signal.

17. A method of testing a MIMO communications device comprising:
receiving up to N input signals from up to N MIMO channels from a transmitter on the MIMO communications device;
shifting each input signal by a shifting frequency so that each MIMO input signal occupies a non-overlapping region of a MIMO bandwidth;
combining one or more of the shifted MIMO input signals to generate a combined, frequency multiplexed MIMO analog signal;
converting the combined frequency multiplexed analog signal to digital samples; and
analyzing the digital samples as MIMO signals using selected signal analysis metrics.

18. The method of claim 17 further comprising:
sending the digital samples to selected signal processing functions using a high speed data fabric.

19. A method for testing a MIMO communications device comprising:
receiving up to N input signals from up to N MIMO channels from a second MIMO communications device;
shifting each input signal by a shifting frequency so that each MIMO input signal occupies a non-overlapping region of a MIMO bandwidth;
combining one or more of the shifted MIMO input signals to generate a combined, frequency multiplexed MIMO analog signal;
converting the combined frequency multiplexed analog signal to digital samples;
demodulating the digital samples to a baseband signal of each input signal received;
upconverting each baseband signal to a copy of the input signal; and
outputting the copies of the input signals to selected outputs connected to the MIMO communications device being tested.
